(19) United States
(12) Patent Application Publication
(10) Pub. No.: US 2010/0001873 A1
(43) Pub. Date: Jan. 7, 2010

(54) AUDIO ENABLED FINANCIAL TRANSACTION ORGANIZERS

(76) Inventors: Carol J. Johnson, Colorado Springs, CO (US); Lisa A. Juhl, Colorado Springs, CO (US); Lynn R. Koldenhoven, Colorado Springs, CO (US); James T. McCall, Manitou Springs, CO (US); Kathy S. Reding, Colorado Springs, CO (US); Heather R. Selph, Papillion, NE (US)

Correspondence Address: SCHWEGMAN, LUNDBERG & WOESSNER, P.A., P.O. BOX 2938, MINNEAPOLIS, MN, 55402, US

(21) Appl. No.: 12/435,464

(22) Filed: May 5, 2009

Related U.S. Application Data
(60) Provisional application No. 61/050,532, filed on May 5, 2008.

(51) Int. Cl. G08B 21/00

(52) U.S. Cl. 340/670

(57) ABSTRACT

Disclosed herein, among other things, is an audio apparatus for a financial transaction organizer. According to various embodiments, the audio apparatus includes a sound module adapted to detect use by a user. The audio apparatus further includes a speaker coupled to the sound module, in various embodiments. The speaker is adapted to output a sound after detecting use by a user.

### RELATED APPLICATIONS

This patent application claims the benefit of priority, under 35 U.S.C. Section 119(e), to U.S. Provisional Patent Application Ser. No. 61/050,532, filed on May 5, 2008, which is incorporated herein by reference in its entirety.

### TECHNICAL FIELD

This application relates generally to financial transaction organizers and more particularly to audio enabled financial transaction organizers.

### BACKGROUND

Check or debit card registers are typically paper based data logs placed in a checkbook cover or debit card holder. Paper based data logs often can be dull or mundane and as a result, users of these registers often neglect to update the register or consult the register before performing a transaction.

Writing checks to pay bills or purchase a product at a retail store can be mundane and as a result, users will procrastinate when paying bills or decide not to use checks during financial transactions related to sale of goods and services. For similar reasons, the practice of updating financial transaction organizers used in conjunction with checks or debit cards can also be mundane.

### SUMMARY

The present subject matter provides an audio apparatus for a financial transaction organizer including a sound module adapted to detect use by a user, and a speaker coupled to the sound module; the speaker outputting a sound after detecting the motion.

This summary is an overview of some of the teachings of the present application and is not intended to be an exclusive or exhaustive treatment of the present subject matter. Further details about the present subject matter are found in the detailed description. The scope of the present invention is defined by the appended claims and their equivalents.

### BRIEF DESCRIPTION OF DRAWINGS

FIG. 1A illustrates an example of a configuration of a financial transaction organizer having a sound module, according to one embodiment of the present subject matter.

FIG. 1B illustrates an example of a configuration of a financial transaction organizer having a sound module, according to one embodiment of the present subject matter.

FIG. 2 illustrates an example of a configuration of a financial transaction organizer cover having a sound module, according to one embodiment of the present subject matter.

FIG. 3 illustrates an example of an insert which can be placed in a checkbook cover or debit card holder to provide sounds when the cover or holder is opened, according to various embodiments of the present subject matter.

FIG. 4 illustrates an example of a configuration of a financial transaction organizer to provide sounds when the organizer is opened, according to one embodiment of the present subject matter.

### DETAILED DESCRIPTION

The following detailed description refers to subject matter in the accompanying drawings which show, by way of illustration, specific aspects and embodiments in which the present subject matter may be practiced. These embodiments are described in sufficient detail to enable those skilled in the art to practice the present subject matter. References to “an”, “one”, or “various” embodiments in this disclosure are not necessarily to the same embodiment, and such references contemplate more than one embodiment. The following detailed description is, therefore, not to be taken in a limiting sense, and the scope is defined only by the appended claims, along with the full scope of legal equivalents to which such claims are entitled.

The present subject matter pertains to method and apparatus for playing sounds when opening a financial transaction organizer, such as a check register, a debit card register, a checkbook cover or a debit card holder. In various embodiments, the sounds are pre-recorded sounds stored in a memory, which is activated by a processor, wherein the memory and processor are part of a sound module. In various embodiments, a sensor is provided within the sound module to detect a motion related to the financial transaction organizer thereby activating the processor. The sensor includes a magnetic sensor, in an embodiment. In various embodiments, the sounds are specially recorded messages. Other sounds are possible without departing from the scope of the present subject matter and as covered by the attached claims.

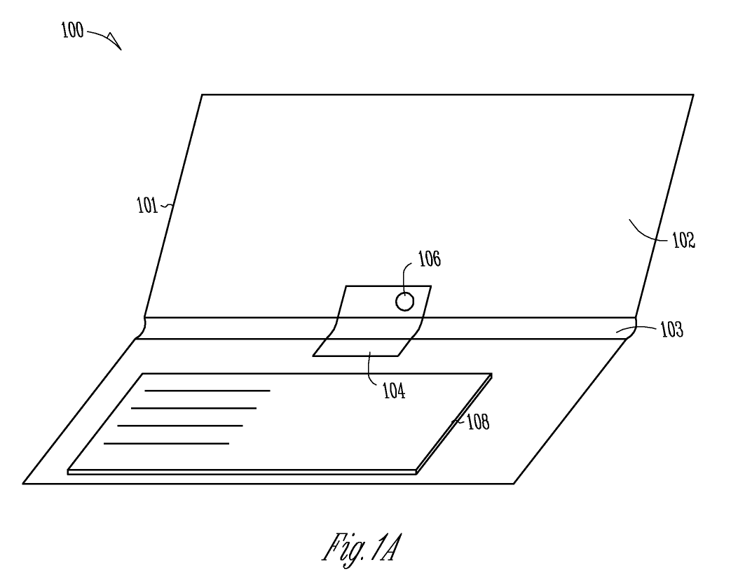

FIG. 1A illustrates an example of a configuration of a financial transaction organizer 100 having a sound module 104 for playing sounds, according to one embodiment of the present subject matter. In various embodiments, financial transaction organizer 100 includes a cover 101 having a flap 102 that is foldable along a crease 103, and accommodates a register 108. Register 108 is used to record various financial transactions related to sale of goods and services. A financial transaction organizer includes, but is not limited to, a checkbook organizer, a debit card organizer, and a credit card organizer. In various embodiments, the checkbook organizer includes a checkbook register, a cover for a book of checks, and a sound module. In various embodiments, the debit card organizer includes a debit card register and a debit card holder for holding a debit card. In various embodiments, a credit card organizer includes a credit card register and credit card holder for holding a credit card.

Upon opening financial transaction organizer 100, the sound module 104 is adapted to play one or more sounds using a speaker 106 provided within sound module 104. In such embodiments, the sound module 104 is affixed to the cover of the financial transaction organizer 100 in such a way as to detect its opening. For example, an adhesive can be used to attach the sound module 104. In some embodiments a mechanical switch is employed which changes state when the cover is opened and activates the sound module 104. Other approaches employ a sensor or detector. Some examples are provided herein. In some embodiments, a microphone (not shown) is provided in the sound module 104, which is capable of recording various sounds. In various embodiments, the sound module 104 can include a user activated on/off switch, volume controls, and recording features including a playback, record, pause, and stop buttons.

FIG. 1B illustrates an example of a configuration of a financial transaction organizer 100 having a sound module 104, according to one embodiment of the present subject matter. In various embodiments, financial transaction organizer 100 is a checkbook cover having upper flap 102 and lower flap 107 that is foldable along a crease 103. Upon opening financial transaction organizer 100, the sound module 104 is adapted to play one or more sounds using a speaker 106 provided within sound module 104. The sound module is affixed to a first self enclosed insert 110 that fits in the upper flap 102 of the organizer 100, in various embodiments. In such embodiments, a second self enclosed insert 112 fits in the bottom flap 107 of the financial transaction organizer 100 in such a way as to detect its opening. In some embodiments one or more sensors 109 are employed on upper flap 102 and lower flap 107 to detect when the cover is opened and activate the sound module 104. The sensors 109 include magnetic sensors, in an embodiment.

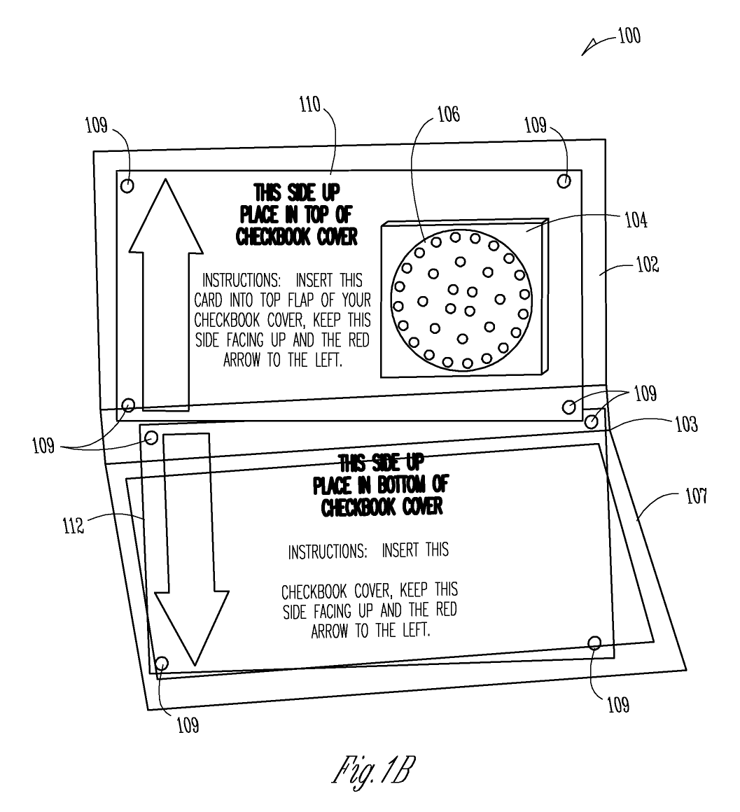

FIG. 2 illustrates an example of a configuration of a financial transaction organizer cover 200 having a sound module 104 disposed in an inner pocket 204 of a sleeve 202, according to one embodiment of the present subject matter. In various embodiments, the sound module 104 includes a speaker to play pre-recorded sounds and a microphone that can be used to record user preferred messages. In such embodiments, the sound module 104 can use a variety of sensors to detect when the cover 200 is in use. Such sensors include, but are not limited to motion, light, and proximity sensors. In light detection embodiments, a small hole may be used to provide illumination to the sensor when the cover 200 is opened. In various embodiments, a financial transaction organizer such as a check register or a debit card register can be affixed to sleeve 202 using an adhesive or other attaching means such as Velcro

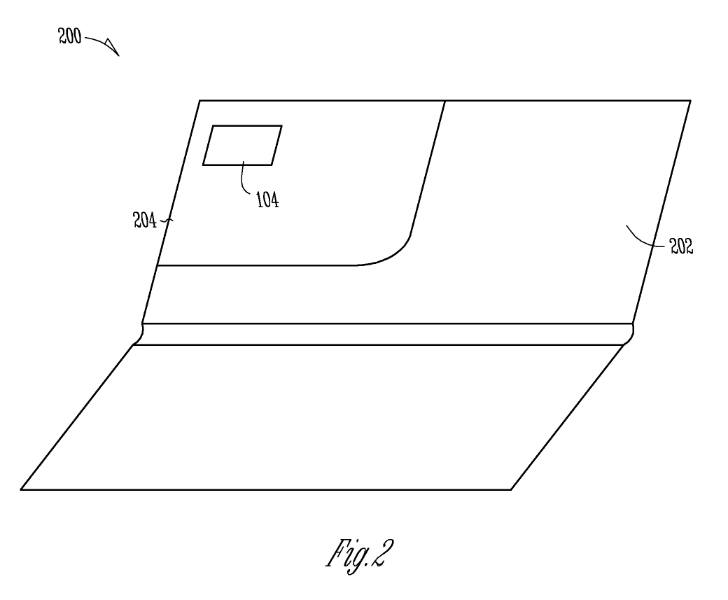

FIG. 3 illustrates an example of an insert 300, which can be placed in a checkbook cover, a debit card holder, or a credit card holder to provide sounds when the cover or holder is opened. The insert 300 includes a sound module 302 which has an actuator 304 or other such opening detector to detect when flap 301 is opened. Sound module 302 will detect opening upon motion of actuator 304. In one example, a first portion of insert 300 can be inserted into upper flap 301 (a first half of a checkbook cover) and a second portion of insert 300 can be inserted into lower flap 303 (a second half of the checkbook cover). In another example insert 300 can be used in conjunction with debit/credit card holder such that when the debit/credit card is removed from the holder, actuator 304 detects the motion and activates sound module 302. It is understood that other detectors, including, but not limited to, motion detectors, light detectors, and/or proximity detectors can be employed without departing from the scope of the present subject matter. In some embodiments, insert 300 may be pre-attached to the check register, a debit card register or a credit card register.

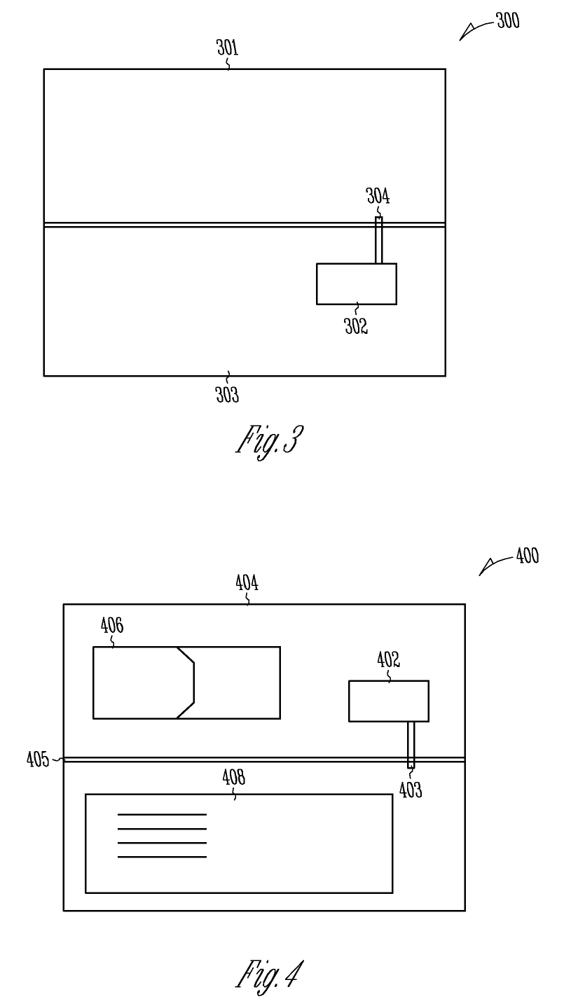

FIG. 4 illustrates an example of a financial transaction organizer 400 to provide sound when the organizer is opened. In various embodiments, the financial transaction organizer 400 includes a cover 404, which is foldable along a crease 405. Financial transaction organizer 400 includes a sound module 402 coupled to a sensor 403 adapted to detect opening of the financial transaction organizer 400. In various embodiments, the financial transaction organizer 400 includes a debit/credit card holder 406. In various embodiments, the financial transaction organizer 400 includes a paper register 408 to record various financial transactions related to sale of goods and services.

In operation, when a user of the financial transaction organizer 400 opens the financial transaction organizer 400 to make a financial transaction, the sound module 402 is adapted to detect the opening using sensor 403. Upon detection of the opening, sound module 402 is activated to play a previously recorded sound. In some embodiments, the sensor is adapted to detect the removal of the debit/credit card from a slot in holder 406. Upon detection of the removal of debit/credit card from holder 406, the sound module 402 is activated to play a pre-recorded sound. In one embodiment, a check book can be attached to the paper register 408. In some embodiments, the sound module 402 is adapted to play a different sound based on whether a check is being written, the paper register 408 is being used, or whether the debit/credit card is being retrieved from holder 406.

In some embodiments, the financial transaction organizer shown in either 100 or 200 is a “singing/talking” check or debit register that uses a pre-programmed or recordable sound module to project sound when a customer uses the check or debit register. The customer will hear the sounds when the register is opened. In some embodiments, the sound module or the insert described above can be inserted into a sleeve within the checkbook cover or a pocket in the debit card holder. In some embodiments, the sound module is activated when the check register is handled. In some embodiments, the sound module includes a microphone that can be used to pre-record sounds that may be played when the check register is handled. In various embodiments, different types of sound messages may be used for different situations based on a given circumstances.

In some embodiments, a “financial management conscience” financial transaction organizer is provided which includes a sound module that can be placed in any one of a check or debit card register, a checkbook cover or a debit card holder. In such an embodiment, when the customer opens the financial transaction organizer, a voice recorded in the sound module would play a voice saying, for example, “Don't even think about buying that.” In some embodiments, the financial management conscience voice may be given to a friend or family member that uses a debit card or checks frequently. Other messages are contemplated and those provided herein are intended to be demonstrative and not exclusive or exhaustive.

In some embodiments, a “self-improvement” financial transaction organizer is provided which includes a sound module that is triggered when a check register, a debit card register, a checkbook cover, or a debit card holder is used, moved or opened. In some embodiments, the sound module, which is placed in a check or debit card register and checkbook cover or debit card holder, would play a voice saying, for example, “Don't even think about buying another doughnut,” when the financial transaction organizer is used. In some embodiments, similar messages for other types of behaviors may be recorded that remind the user to refrain from entertaining a certain habitual pattern that seems to be a recurring problem. Other messages are contemplated and those provided herein are intended to be demonstrative and not exclusive or exhaustive.

In some embodiments a “recordable to-do list” financial transaction organizer is provided which includes a sound module that is triggered when any one of a check register, a debit card register, a checkbook cover or a debit card holder disposed within the financial transaction organizer is used. In various embodiments, the sound module is triggered upon being moved or opened. In such embodiments, the customer can have the ability to record a “to-do” list with a record feature. The recordable sound module would include features such as record, playback, delete, and pause. For example, if a spouse needed milk at the grocery store they could record a message such as, “Don't forget the milk,” to be played when the check or debit card register or checkbook cover or debit card holder is used. Other recorded messages are contemplated and those provided herein are intended to be demonstrative and not exclusive or exhaustive.

In some embodiments an “affirmation” financial transaction organizer is provided which includes a sound module placed in a check or debit card register and checkbook cover or debit card holder having a voice that would give the user of the register affirmation. In some embodiments, the sound module may be recorded with a voice that recites a phrase such as “You are looking good today.” Other messages are contemplated and those provided herein are intended to be demonstrative and not exclusive or exhaustive.

The sound modules referenced herein may include a variety of electronics and memory to play a sound. Embodiments include, but are not limited to, processors such as a microprocessor, a digital signal processor, a microcontroller, or a dedicated sound chip. Such designs may use available memory or may include separate memory. Each sound module may include a battery. The sound modules discussed herein can include a microphone in embodiments where sound may be recorded by the user. A variety of sensors as discussed herein may also be employed, including, but not limited to motion, light, and proximity sensors. Designs may also employ buttons or other inputs to control the operation of the device where necessary. For example, such designs may include buttons to initiate recording or step through multiple messages/greetings as described herein. Sound module designs may employ very small and thin form factors which are unobtrusive and inexpensive to manufacture. Other designs exist within the scope of the present subject matter which are not expressly stated herein.

It is understood that sound modules may be used to improve conventional checkbook organizers, credit/debit card organizers, and/or their registers. Such sound modules may be placed accordingly using adhesives to affix the sound module and any mechanical actuators, if employed, to a conventional cover and/or register. In various embodiments, sound modules may be placed in a checkbook cover by situating self enclosed inserts under checkbook cover flaps.

It is understood that other combinations and configurations may be employed without departing from the scope of the present subject matter. This application is intended to cover adaptations or variations of the present subject matter. It is to be understood that the above description is intended to be illustrative, and not restrictive. The scope of the present subject matter should be determined with reference to the appended claims, along with the full scope of equivalents to which such claims are entitled.

What is claimed is:

1. An apparatus, comprising:
a financial transaction organizer including a cover;
a processor disposed in the cover, the processor configured to detect a motion associated with the financial transaction organizer; and
a speaker coupled to the processor, the speaker outputting a sound based on motion detected by the processor.

2. The apparatus of claim 1, wherein the financial transaction organizer includes a check register.

3. The apparatus of claim 1, wherein the financial transaction organizer includes a debit card register.

4. The apparatus of claim 1, wherein the financial transaction organizer includes a checkbook cover.

5. The apparatus of claim 1, wherein the financial transaction organizer includes a debit card holder.

6. A sound module, comprising:
a sensor adapted to detect a use of a financial transaction organizer;
a speaker; and
a processor connected to the sensor and speaker, the processor adapted to activate the speaker to play the pre-recorded sound upon detection of the use of the financial transaction organizer.

7. The sound module of claim 6, wherein the sensor includes a motion detector.

8. The sound module of claim 6, wherein the sensor includes a light detector.

9. The sound module of claim 8, wherein the financial transaction register includes a cover having a small hole, the hole adapted to provide illumination to the sensor when the cover of the financial transaction organizer is opened.

10. The sound module of claim 6, further comprising a microphone connected to the processor, the microphone adapted to be used to record user preferred messages.

11. A system, comprising:
a financial transaction organizer;
a sound module coupled to the financial transaction organizer, the sound module including:
a sensor adapted to detect a use of the financial transaction organizer;
a memory to store a pre-recorded sound;
a speaker; and
a processor connected to the sensor, memory and speaker, the processor adapted to activate the speaker to play the pre-recorded sound upon detection of the use of the financial transaction organizer.

12. The system of claim 11, wherein the sound module further includes a user activated on/off switch.

13. The system of claim 11, wherein the sound module further includes a volume control.

14. The system of claim 11, wherein the sound module further includes a recording feature control, the recording feature control including at least one of a playback button, a record button, a pause button and a stop button.

15. The system of claim 11, wherein the financial transaction organizer includes a cover, and the sensor is adapted to detect motion of the cover.

16. A method, comprising:
detecting a use of a financial transaction organizer; and
playing a pre-recorded sound upon detection of the use of the financial transaction organizer.

17. The method of claim 16, further comprising:
attaching a sound module to the financial transaction organizer, the sound module adapted to detect the use and play the sound.

18. The method of claim 17, wherein attaching a sound module includes attaching the module using an adhesive.

19. The method of claim 16, wherein detecting a use of a financial transaction register includes detecting motion of a cover of the financial transaction organizer.

20. The method of claim 16, wherein playing a pre-recorded sound includes playing a user preferred message.
